(19) United States
(12) Patent Application Publication
(10) Pub. No.: US 2004/0043754 A1
(43) Pub. Date: Mar. 4, 2004

(54) Cellular telephone billing method

(76) Inventor: Jean E. Whewell, Georgetown, TX (US)

Correspondence Address: Christopher J. Whewell, Western Patent Group, 6020 Tonkowa Trail, Georgetown, TX, 78628, US

(21) Appl. No.: 10/230,852

(22) Filed: Aug. 29, 2002

(51) Int. Cl. H04M 15/00; H04M 17/00; H04M 11/00

(52) U.S. Cl. 455/408; 379/144.01; 379/114.2

(57) ABSTRACT

Provided herein is a variable billing plan which calculates the lowest possible invoice amount to be billed to a consumer of cellular services from a variety of billing options. Through use of a billing method according to the invention, consumer loyalty is increased at negligible expense to bandwidth consumption.

### TECHNICAL FIELD

This invention relates to cellular telephone service and billing plans useful by providers of such service to invoice their customers for such service.

### BACKGROUND

Cellular telephone services are in widespread use. Providers of such services offer different billing plans to prospective customers under which the different plans have differing amounts of threshold levels of minutes that a user may consume for a flat fee. If the user exceeds the threshold amount of plan minutes within a given billing cycle, the user must pay a rate per minute for minutes in excess of the plan amounts. Often, the rate per minute for minutes used in excess of the plan threshold level of minutes is punitive in a sense that it is much higher than the rate per minute calculated from the basic plan amount divided by the number of threshold minutes provided under such a plan. This puts the consumer at a disadvantage as far as cost is concerned with respect to minutes consumed beyond the plan amount, and my cause negative feelings in the mind of the consumer towards the service provider, thus causing the consumer to break a contract or to seek alternative sources of cellular services after expiry of a contract. What is needed therefore, is a billing plan which does not penalize consumers for excessive use of cellular services and which increases consumer loyalty to a provider of cellular services.

### SUMMARY OF THE INVENTION

The present invention provides a variable billing plan method for calculating an invoice amount for a consumer of cellular telephone services during a service interval. A method according to the invention comprises the steps of: a) offering a consumer a plurality of billing schedules from which to choose, wherein each of the schedules includes a pre-determined threshold level of given plan minutes which are billed at a flat rate and a rate per minute for each minute of service used which exceeds the threshold level, and wherein each of the plurality of billing schedules offered includes a different amount of pre-determined threshold level of given plan minutes: accepting a billing schedule choice selection from the consumer, wherein the choice includes a predetermined threshold level of given plan minutes which are billed at a flat rate and a rate per minute for each minute of service used which exceeds the threshold level; c) providing cellular telephone service to the consumer during a service interval; d) calculating an invoice amount based upon the accepted billing schedule choice by combining the total dollar values of the flat rate and an addend that is calculated by multiplying the number of minutes of service used that exceed the threshold level by the rate per minute charged for each minute exceeding the threshold level; e) calculating a hypothetical invoice amount based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected; f) repeating step e) for each of all of the plans offered but not selected, so as to provide a hypothetical invoice amount for each plan not selected; g) comparing the hypothetical invoice amount(s) with the invoice amount from step d) to determine which out of all of the invoice amount and the hypothetical invoice amount(s) is the least dollar value; and h) issuing an invoice to the customer using the least dollar value as a pre-tax basis for the invoice.

### DETAILED DESCRIPTION

Cellular service providers offer the public different billing plans from which each individual user may choose, which best suits their personal calling needs. Typically, such services offer several different billing schedules to prospective customers to entice them to enter into contractual obligations with the service provider. Typically, the billing schedules offered include a pre-determined threshold level of minutes that the consumer may use, in exchange for a flat billing amount. In the event that the consumer utilizes more minutes of cellular service than specified as the pre-determined threshold level, the consumer is billed on a per-minute basis for each minute in excess of the threshold level of minutes in the plan accepted by the consumer. The invoice at the end of the service interval, which is typically monthly, is calculated by adding the total dollar values of the flat rate and an addend that is calculated by multiplying the number of minutes of service used that exceed the threshold level by the rate per minute charged for each minute exceeding the threshold level. Taxes and other fees may then be added on and a final invoice amount is billed to the consumer.

A typical offering of a plurality of billing schedules is set forth below in Table I:

TABLE I
common plurality of billing schedule options offered
to consumers of cellular service.

| | Monthly Service | Threshold Level | Additional Minutes |
|---|---|---|---|
| Plan Number | Charge | of Minutes | Cost |
| 1 | $34.99 | 300 | 40 cents |
| 2 | $49.99 | 500 | 40 cents |
| 3 | $74.99 | 1000 | 40 cents |
| 4 | $99.99 | 1300 | 40 cents |
| 5 | $149.99 | 2200 | 40 cents |
| 6 | $199.99 | 3200 | 40 cents |

Thus, a consumer operating under plan 1 who used 400 minutes per service interval would be invoiced an amount equal to the monthly service charge of $ 34.99 plus an additional $ 40.00, derived from multiplying 100 minutes excessive of the threshold level of 300 minutes times the rate of 40 cents per minute.

Similarly, a consumer operating under plan 1 who used 600 minutes during the service interval would be invoiced based on an amount of $ 34.99 plus $ 120.00.

Certainly, it is to the consumer's advantage to select the plan which is well-suited to their individual needs. However, prediction of service usage by consumers is not always accurate due to fluctuating individual needs. If a cellular service provider were to offer their consumers and prospective consumers a variable rate billing plan which saved the consumer money during unpredictable fluctuations in their service, the consumer would appreciate the cost savings that such a variable billing plan would offer. A cellular service provider which offered a variable billing plan according to the invention would be very likely to attract customers away from their competition, and would appreciate significant long-term overall financial gains relative to their competition realized by an increased subscriber base, with relatively little increase in bandwidth usage.

According to the present invention the regular amount that a consumer would be billed under an accepted billing schedule is calculated. Then, a hypothetical invoice amount is calculated based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected. This is repeated for each of the plans that were offered but not selected, so as to provide a hypothetical invoice amount for each plan not selected. Then, the hypothetical invoice amount(s), (when more than two plans were offered to the consumer) are compared with the regular amount that the consumer would be billed under the accepted billing schedule (the “actual amount”) to determine which dollar value out of all of the hypothetical and actual amounts is the lowest cost to the consumer. The lowest value is selected as a basis for invoicing the customer, to which taxes and other customary fees are added to yield a final invoice amount which must be paid by the consumer.

In one preferred embodiment of the invention, in exchange for the valuable variable billing plan according to the invention, the consumer of cellular services is levied a surcharge on their invoice for the use of the variable plan.

Thus, a consumer of cellular services operating under plan 1 of Table I who uses 400 minutes in the service interval would have an actual amount for billing as set forth in Table III below next to plan 1, with the rest of the dollar values being the hypothetical invoice amounts:

TABLE II
Invoice amounts for person operating under plan 1 from Table I
who uses 400 minutes of service during the service interval.

| Plan Number | Invoice Amounts |
|---|---|
| 1 | $74.99 (actual) |
| 2 | $49.99 (hypothetical) |
| 3 | $74.99 (hypothetical) |
| 4 | $99.99 (hypothetical) |
| 5 | $149.99 (hypothetical) |
| 6 | $199.99 (hypothetical) |

According to the present invention, the dollar figures from the right-hand column of Table II would be compared with one another to discover that the lowest dollar amount is $ 49.99. This is the amount which would be used as a basis for calculating the consumer's invoice, thus saving the consumer $ 30.00. The service provider, in one embodiment, would charge the consumer a surcharge for the use of a plan according to the present invention, which could be any amount between 0 and the amount saved. While it is most preferred that the surcharge is about one-half of the savings to the consumer, the present invention contemplates surcharges which are any dollar value between zero and the amount saved through use of the plan.

As another example, a consumer operating under plan 1 in Table I who uses 600 minutes of service would have an actual amount for billing as set forth in Table III below next to plan 1, with the rest of the dollar values being the hypothetical invoice amounts:

TABLE III
Invoice amounts for person operating under plan 1 from Table I
who uses 600 minutes of service during the service interval.

| Plan Number | Invoice Amounts |
|---|---|
| 1 | $154.99 (actual) |
| 2 | $89.99 (hypothetical) |
| 3 | $74.99 (hypothetical) |
| 4 | $99.99 (hypothetical) |
| 5 | $149.99 (hypothetical) |
| 6 | $199.99 (hypothetical) |

Thus, the lowest billing amount for a person operating under plan 1 who uses 600 minutes of service but calculated according to a method of the present invention would be $ 74.99. This could represent a maximum amount of savings of $ 80.00 to the consumer.

Use of a variable billing method according to the invention would not only attract consumers away from competitors in the cellular service market, but would also save consumers money while not adversely impacting bandwidth usage, all while increasing consumer loyalty.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims which follow.

I claim:

1) A variable billing plan method for calculating an invoice amount for a consumer of cellular telephone services during a service interval which comprises the steps of:
a) offering a consumer a plurality of billing schedules from which to choose, wherein each of said schedules includes a pre-determined threshold level of given plan minutes which are billed at a flat rate and a rate per minute for each minute of service used which exceeds said threshold level, and wherein each of said plurality of billing schedules offered includes a different amount of pre-determined threshold level of given plan minutes;
b) accepting a billing schedule choice selection from said consumer, wherein said choice includes a pre-determined threshold level of given plan minutes which are billed at a flat rate and a rate per minute for each minute of service used which exceeds said threshold level;
c) providing cellular telephone service to said consumer during a service interval;
d) calculating an invoice amount based upon the accepted billing schedule choice by combining the total dollar values of said flat rate and an addend that is calculated by multiplying the number of minutes of service used that exceed said threshold level by the rate per minute charged for each minute exceeding said threshold level,
e) calculating a hypothetical invoice amount based upon a billing plan that was offered to said consumer but which was not selected by said consumer, using the actual minutes of service used by said customer during said service interval, by combining the dollar value for the threshold level of given minutes for the plan not selected, and the rate for each minute in excess of said threshold level for said plan not selected, to arrive at a hypothetical invoice amount for a plan not selected;
f) repeating step e) for each of all of the plans offered but not selected, so as to provide a hypothetical invoice amount for each plan not selected;
g) comparing said hypothetical invoice amount(s) with said invoice amount from step d) to determine which out of all of said invoice amount and said hypothetical invoice amount(s) is the least dollar value; and
h) issuing an invoice to said customer using said least dollar value as a pre-tax basis for said invoice.

2) A process according to claim 1 wherein a surcharge is added to said least dollar value as a premium for use of such variable billing plan method.

3) A process according to claim 2 wherein said surcharge is a non-varying rate.

4) A process according to claim 2 wherein said surcharge is variable, depending upon the total number of minutes in excess of the threshold level of given plan minutes in the accepted billing schedule.

5) A process according to claim 2 wherein said surcharge is only applied to an invoice sent to the consumer for a fraction of the billing cycles within a contract term between said consumer and said service provider.
